(19) United States
(12) Patent Application Publication
(10) Pub. No.: US 2026/0203320 A1
(43) Pub. Date: Jul. 16, 2026

(54) FORGETTING MECHANISM USING ZONE OF INFLUENCE FOR LONG-TERM LLM-BASED AGENTS

(71) Applicant: Dell Products L.P., Round Rock, TX (US)

(72) Inventors: Herberth Birck Fröhlich, Florianópolis (BR); Marcus Vinicius Libardi Pazini, Caxias do Sul (BR); Werner Spolidoro Freund, Rio de Janeiro (BR)

(21) Appl. No.: 19/025,158

(22) Filed: Jan. 16, 2025

(51) Int. Cl. G06F 16/3329; G06F 12/02

(52) U.S. Cl. CPC G06F 16/33295; G06F 12/0238

(57) ABSTRACT

Techniques for generating an LLM response are disclosed. A service accesses information pertaining to a conversation between a user and the LLM. The service converts the information into a memory item. The service accesses an existing memory bucket, which is associated with a curve of retention. In response to determining that a characteristic of the memory item satisfies a threshold level of similarity, the service causes the memory item to be included in the existing memory bucket. The service reinforces the retention for the existing memory bucket and triggers an LLM reading procedure.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to providing an LLM response to a conversation with a user. More particularly, at least some embodiments relate to systems, hardware, software, computer-readable media, and methods for improving how LLM responses are generated.

### BACKGROUND

Large Language Model (LLM) based agents are gaining popularity due to their autonomy and impersonating capability. These agents can interact with users using a predefined persona and can seek resources when a request cannot be solved or answered locally or directly by the model's currently available knowledge or tools.

These user interactions may last for more than one session. Often, a user might refer implicitly to earlier pieces of information. As a consequence, it is desirable to efficiently handle conversation memory. Furthermore, multi-agent scenarios can likewise require unified memory banks because these agents might collaborate within the same context.

There are various reasons as to why it is desirable for an LLM-based agent to have memory. These reasons include, but are not limited to, the perception of an LLM's cognitive psychology from the viewpoint of the user (e.g., agents can resemble humans); self-evolution (e.g., experience accumulation, environment exploration, and knowledge abstraction); and agent applications (e.g., keeping the agent's role).

To cope with the memory requirement, agents are typically imbued with memory mechanisms. These mechanisms are classified based on (i) the sources of content (e.g., within the current session, cross sessions, or external), (ii) the form the content is used (e.g., textual, parametric, etc.), and (iii) the related operations (e.g., writing, management, and reading).

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example retention rate for a memory bank of an LLM agent.

FIG. 2 illustrates a computing architecture for generating an LLM response.

FIG. 3 illustrates a process flow for generating a response.

FIGS. 4, 5, and 6 illustrate example algorithms.

FIGS. 7, 8, and 9 illustrate examples of modifying retention curves and assigning memory items to buckets.

FIGS. 10 and 11 illustrate flowcharts of example methods for generating an LLM response.

FIG. 12 illustrates an example computer system that can be configured to perform any of the disclosed operations.

### DETAILED DESCRIPTION

As mentioned earlier, agents are imbued with memory mechanisms. Mechanisms that are particularly of interest include cross session mechanisms, text mechanisms, management-based mechanisms, and mechanisms resembling a human's long-term memory.

A mechanism is a “cross session” mechanism when memories remain and can be accessed even in different contexts and sessions. A mechanism is “textual” when the LLM architecture is not changed to incorporate the memory information. A mechanism is “management-based” when the LLM addresses the way memory is reinforced or weakened as interactions happen by using multiple forgetting curves. In some implementations disclosed herein (as will be discussed in more detail later), the disclosed memory management is based on the Flash Cards theory.

A forgetting mechanism is a type of management strategy. Traditional forgetting mechanisms fail to consider knowledge inter-relations, such as the zone of influence that a memory has in relation to other memory concepts. For example, consider a scenario where a person reads a novel. It is likely that the person is improving his/her vocabulary and literature writing knowledge while reading the novel.

The disclosed embodiments are beneficially able to leverage the already established Ebbinghaus Forgetting Curve concept to achieve improved LLM behavior. Some particular benefits provided by the embodiments relate to the zone of influence propagation and to the adapted forgetting mechanism.

One unique aspect of the disclosed embodiments lies in propagating the information across related memory buckets (i.e. categories of stored information obtained from a conversation with a user) and their respective memory items with different intensities according to a “Zone of Influence.” That is, memory buckets that are identified as being different yet sufficiently similar will be impacted when one of those memory buckets is called upon. By doing so, the embodiments present to the user tiered pieces of memory to be used for better prompt building thus enhancing LLM-based chatbots and tool-based agents for various purposes.

The disclosed embodiments can optionally assume that there is a writing mechanism that retrieves pieces of information from the conversation and stores them into memory buckets according to a similarity measure. One strategy to do that is to use a Locality Sensitive Hashing (LSH) technique with a Random Projection technique. With these techniques, each sentence of interest coming from the agent-user interaction becomes a triplet that is hashed and then attributed to the proper memory buckets.

In some embodiments, the management mechanism is based on the Flash Cards theory. According to the Flash Cards theory, characteristics or features that make something memorable are based on repetition, association, context, and emotion. The repetition is considered using a “forgetting curve” while the association and context are driven by a “zone of influence” propagation. Listed below are some relevant descriptions for this disclosure.

“Forgetting Curves” or “Curves of Retention” are one topic of interest. In accordance with the disclosed principles, one forgetting curve is provided for each memory bucket. Also, one forgetting curve is provided for each underlying bucket item (called a “memory item”) in that memory bucket. What this means is that one forgetting curve is responsible for managing the context and one or more other curves manage each item that form this context. This technique defines the retention of a memory item as a function of the number of past interactions.

“Reinforcement Procedure” is another topic of interest. Here, during each interaction, the activated memory bucket has its zone of influence analyzed. In other words, the activated memory bucket is checked to what degree the current memory bucket is related to the other memory buckets in terms of a percentage. This checking process can be done using the same similarity measure approach that was used during the bucket building. Then, the forgetting curve of the current bin/memory bucket is updated with a full (100%) intensity value, while the related contexts are updated proportionally to the similarity value (e.g., normalized to percentage range). For instance, if a similar bucket is similar to the degree of 80%, then that similar bucket will be updated with an 80% intensity value.

Furthermore, the highest similar memory item within the activated bucket also has its retention reinforced. The reinforcement also occurs during the LLM reading procedure. By way of example, if a memory item is triggered (in other words, “remembered”), its retention is increased; however, the associated bucket is not reinforced in this case.

“Memory Weakening” is another topic of interest. Here, memory buckets are weakened by progressively updating the interactions of their forgetting curves based on a defined decay factor. Memory items are dropped from the memory bank if the retention is below a threshold, which can optionally be provided by a user or can be intelligently defined by a machine learning (ML) engine.

One objective of memory management is to reduce the reading and writing costs by keeping only useful information stored in a proper way. Memory management often relies on concepts that resemble how humans deal with memory (e.g., information that is often used is kept fresh in the memory while unused information is slowly forgotten). Listed below are four memory retention/forgetting mechanisms. This disclosure provides a brief description of each technique and highlights its limitations and shortcomings.

The first technique is the “Memory Bank” technique. The mechanism is built around anthropopathic scenarios, thus forgetting less important pieces of information that have not be used often, thereby allowing artificial intelligence (AI) companions to feel more natural. Memory banks employ the Ebbinghaus Forgetting curve to do that. The Ebbinghaus Forgetting curve is a principle that models how the strength of memory decreases over time. To model the forgetting mechanism, the mechanism uses a rate of forgetting, a “time-tracking” variable, and a memory delay and a spacing effect. The model also defines an exponential decay curve of knowledge retention as a function of time.

The model also assumes certain simplifications, and the way the curve is updated is exploratory in nature. The most prominent simplification is the memory strength; that is, the model views this parameter as a discrete value. If the information is seen again, the curve will be reinforced; otherwise, the curve progresses in time. An assumption is also made that each piece of information drawn from the dialogue has its own unique curve, and the context is not taken into consideration. The disclosed embodiments build on the memory bank technique by using multiple levels of forgetting curves and by triggering reinforcements considering a zone of influence between memory buckets.

A second technique is the Think-in-Memory (TiM) technique. Here, the forgetting mechanism uses a few-shot based LLM prompt to remove the counterfactual or contradictory thoughts to keep the memory bank as clean as possible to avoid unnecessary comparisons. There is not a reinforcement mechanism or intelligent process that uses the frequency that a piece of information is used.

A third technique is the Generative Agent technique. Here, this memory management mechanism stores all past events in a file. During a reading stage (e.g., the LLM reading procedure), it considers the importance (e.g., mundane from core memories) and relevancy (e.g., how strong the memory is related to the context) to build a retrieval score. For this disclosure, it is relevant to know that this technique also presents a single exponential decay mechanism for memory objects with fixed decay factor.

A fourth, final technique is the RecAgent technique. Here, long-term memories can be forgotten based on a probability function of importance and timestamp. Thus, memories that are relevant and recent have less probabilities of being erased. This technique uses a power function to model each memory piece of information. Memory includes content data, timestamp data, and importance data. There is also a strength parameter that finds the shape of the power curve. Once again, there is no connection between memory objects.

As mentioned earlier, according to flash cards theory, there are few things that make something memorable; these things include: repetition, association, context, and emotion. The disclosed embodiments take a unique approach by combining these elements with the forgetting curve and the zone of influence. To do so, the repetition is the frequency that the same information is reviewed. In this disclosure, the embodiments incorporate this feature using a forgetting curve. Association is the relation between new information and previous knowledge. In this disclosure, the embodiments incorporate this feature using the zone of influence between memory buckets. Context eases the information recall. The embodiments alter the LLM reading procedure of the memory mechanism to use memory buckets.

Regarding the memory mechanisms, Expression 1 (below) shows how an LLM agent's next action that leverages memory can be formalized based on the three main memory operations (i.e. reading, management, and writing). Notice, to execute the next action, the LLM request uses writings about the current action and observations about the interaction. Then, the LLM checks the context to decide how to manage the memory content. Now, with the updated memory bank, the LLM reads and extracts the useful information from the memory bank for prompt building.

$$NextAction = LLM ( Reading ( Management ( Writing ( CurrentAction , \\ Observation ) ) ) , Context ) \qquad Expression 1$$

Expression 1 depicts how memory content is used to support the agent's decision. For this disclosure, it is relevant to notice the sequence of the events and how all three properties are required for a full memory mechanism to work.

Regarding the forgetting curves, the forgetting curves depict the strength of a memory as a function of time. Such curves follow three principal rules. One rule states that these curves have a rate of forgetting stating that the retention decreases over time. Another rule states that these curves are steep at the beginning, which means that the memory strength rapidly decays in hours and days. This property is known as time and memory decay. Another rule states that there is a spacing effect, meaning that it is easier to relearn things than to learn something for the first time. Some embodiments disclosed herein do not consider the spacing effect or relearning. Most embodiments described herein are focused on the forgetting mechanism to spare storage and processing power.

The forgetting curve can be modeled as an exponential function. The forgetting curve can be represented by Expression 2, below.

$$R = {e}^{- timeTag / D} \qquad Expression 2$$

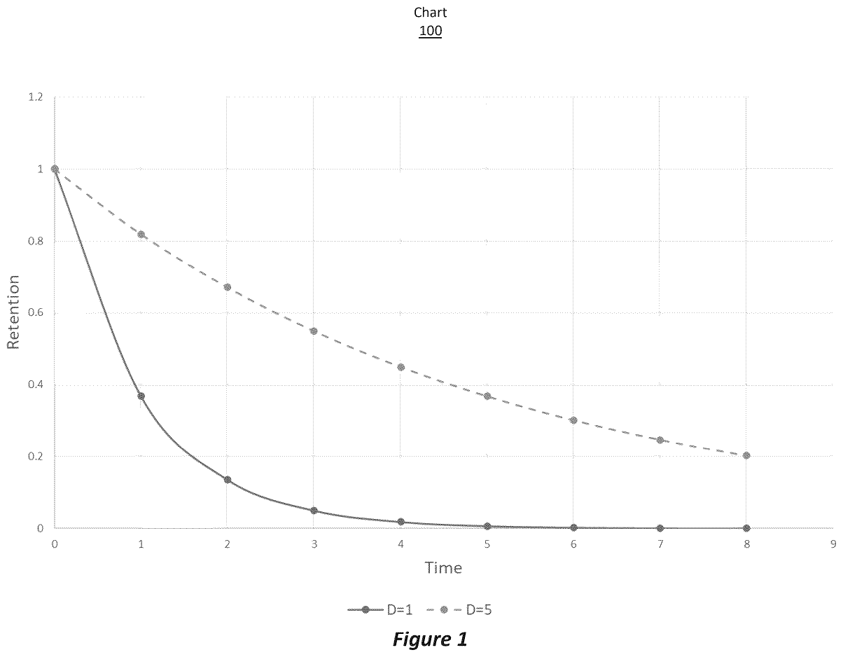

In Expression 2, R is the retention, timeTag is the elapsed time, and D is a constant that rules the rate of forgetting (e.g., memory decaying). Through such constants, one can translate and/or change the aspect of the curve to better reflect memory retention. FIG. 1 displays a chart 100 showing a forgetting curve when D=1 and when D=5. Notice the sudden drop in retention already at timestep 5 when D=1. There might be scenarios where 5 steps (e.g., seconds, minutes, interactions) would occur fast, and the retention should not drop as fast as that. To cope with such situations, some embodiments disclosed herein can assume that the D is application dependent and is given by the user. Guidance to support the decision is provided later.

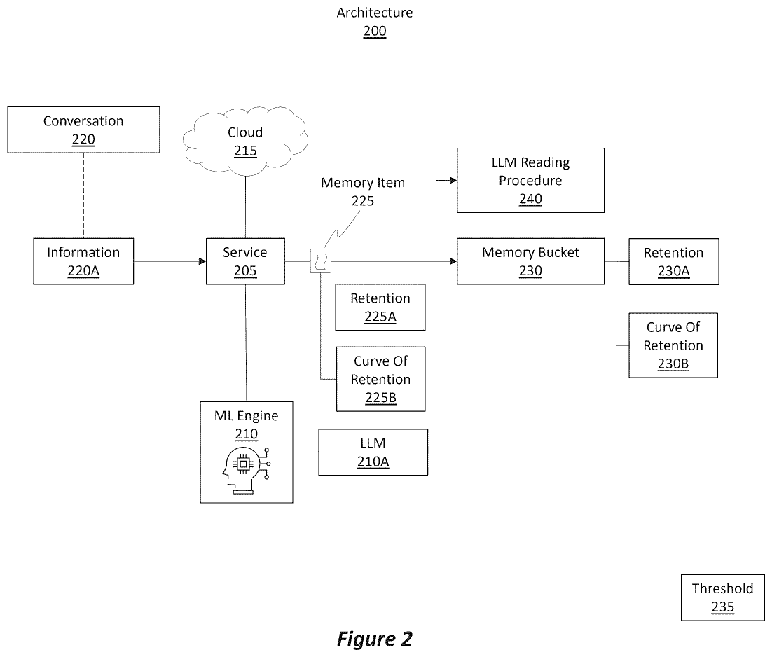

Having just provided some context information and some details regarding some of the benefits and advantages provided by the disclosed embodiments, attention will now be directed to FIG. 2, which illustrates an example architecture 200 in which the disclosed principles may be employed. Architecture 200 shows a service 205.

As used herein, the term “service” refers to an automated program that is tasked with performing different actions based on input. In some cases, service 205 can be a deterministic classifier that operates fully given a set of inputs and without a randomization factor. In other cases, service 205 can be or can include a machine learning (ML) or artificial intelligence engine, such as ML engine 210. The ML engine 210 enables service 205 to operate even when faced with a randomization factor. The ML engine 210 may include an LLM 210A.

As used herein, reference to any type of machine learning or artificial intelligence (or large language model (LLM)) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a local service operating on a local device, such as an edge device. In some implementations, service 205 is a cloud service operating in a cloud 215 environment. In some implementations, service 205 is a hybrid service that includes a cloud component operating in the cloud 215 and a local component operating on a local device. These two components can communicate with one another.

Service 205 is generally tasked with facilitating or assisting the LLM 210A to generate a response to a conversation 220 between the LLM 210A and a user. To do so, service 205 accesses information 220A pertaining to the conversation 220. The information 220A can be snippets from the conversation 220, specific words from the conversation 220, topics, metadata, or any other information describing the conversation 220.

Service 205 then converts the information 220A into a memory item 225, which will be described in more detail later. Service 205 accesses an existing memory bucket, such as memory bucket 230. Memory bucket 230 is a grouping of memory items having characteristics that are determined to be within a threshold level of similarity (e.g., as generally illustrated by threshold 235) relative to one another. Notably, the existing memory bucket 230 has a retention 230A that generally reflects the memory strength of the memory bucket 230 and a curve of retention 230B that governs that memory strength. The curve of retention 230B has a decay factor that progressively minimizes the memory strength over time. Any number of memory buckets may be included in architecture 200. Often, the memory buckets are generated based on the details of the conversation 220.

Notably, the memory item 225 is also assigned or associated with a corresponding retention 225A as well as a curve of retention 225B. The curve of retention 225B governs the retention 225A.

In response to determining that a characteristic of the memory item 225 satisfies the threshold level of similarity relative to the characteristics of the memory items in the existing memory bucket, service 205 causes the memory item 225 to be included in the existing memory bucket 230. If, however, the memory item 225 was not sufficiently similar to those items included in memory bucket 230, then a new memory bucket would be created. Further details on that aspect will be provided later. For this example, however, service 205 determines that the memory item 225 is sufficiently similar to the items in memory bucket 230. As such, memory item 225 is included in the memory bucket 230.

Because memory item 225 is included in memory bucket 230, service 205 reinforces the retention 230A for the existing memory bucket 230 by updating the curve of retention 230B for the existing memory bucket 230. If memory item 225 were included in a different memory bucket, then that different memory bucket's retention would be reinforced. Regarding the zone of influence mentioned earlier, service 205 may identify other memory buckets that, although different from memory bucket 230, still share some similarity with memory bucket 230. Because memory bucket 230 was reinforced, those other similar buckets will also be reinforced, but the amount by which they are reinforced is smaller than the amount by which memory bucket 230 is reinforced. This tandem reinforcement forms the zone of influence between memory buckets.

Service 205 also triggers an LLM reading procedure 240. During this procedure, memory buckets (e.g., memory bucket 230) are searched in an attempt to identify data that is usable to provide an LLM response for the conversation. The LLM reading procedure 240 is structured to assume that whichever memory bucket has the highest retention (as compared to the other memory buckets), that bucket is relatively more likely to include the data that is usable to provide the LLM response.

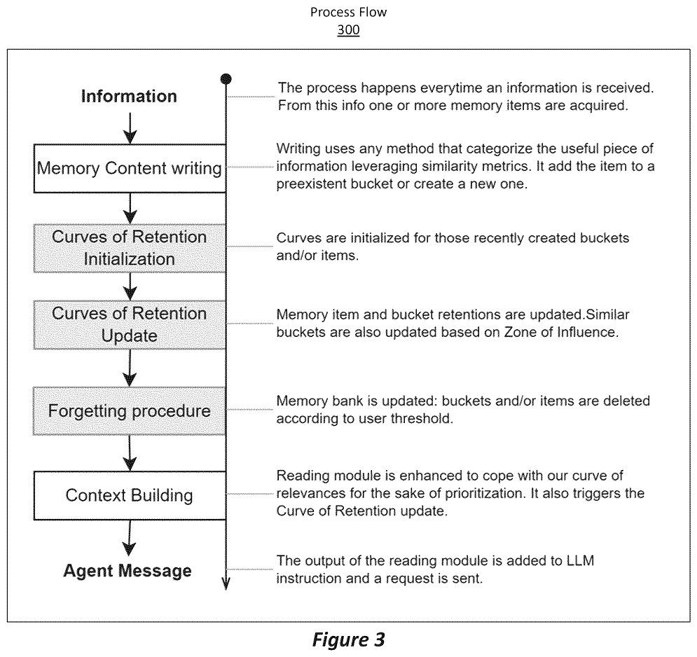

FIG. 3 provides additional context relative to the operations of service 205. As such, frequent reference will be made between the architecture 200 of FIG. 2 and the process flow 300 of FIG. 3. Specifically, service 205 is tasked with performing at least some of the steps outlined in process flow 300.

The disclosed solutions start when a message (e.g., information 220A) arrives at service 205, thereby triggering a memory content writing event shown in FIG. 3. A writing mechanism of service 205 (e.g., MemGPT or TiM) receives this message, parses the content in the message, converts the parsed content into one or memory items (e.g., memory item 225), and then writes the information into categories, which are referred to herein as “memory buckets” (e.g., memory bucket 230). Forgetting curves, which are also referred as “Curves of Retention” (e.g., curve of retention 230B) are created (or initialized, as shown in FIG. 3) and associated to newly created buckets and to newly created memory items within the buckets.

The management step is where the curves of retention are updated (as shown in FIG. 3 by “Curves of Retention Update”) and is where significant benefits are found. For preexisting buckets, after a new memory item becomes a part of it, the retention for that bucket is reinforced. If there is redundancy between preexisting memory items, the redundant memory item's retention is also increased. When a bucket is triggered, it will also trigger similar buckets based on their similarity measures, as described earlier with respect to the zone of influence.

Then, the forgetting procedure shown in FIG. 3 occurs. Here, if a bucket has a retention below a given threshold (e.g., threshold 235 shown in FIG. 2), the bucket is dropped (i.e. deleted). If a memory item has a retention below the memory threshold, the memory item is dropped.

The last stage of process flow 300 is the reading for “Context Building.” The LLM reading procedure assumes that the bucket with the highest retention is more likely to contain the information that will support the agent's decision due to the similarity between the incoming information and this bucket's content. If an item from within the triggered bucket is utilized for context building, the respective memory item has its retention increased.

It is relevant to notice that the disclosed solutions are not directly related to system storage characteristics and/or processing capabilities. For example, it is often not relevant for process flow 300 if the system is unable to retain more information or has storage to spare, thereby signaling that no memory items should be deleted. Besides that, during the reading for the context building procedure, an option is available for the user to decide if the buckets and memory item retentions will matter during concept building. The user might want to prioritize those buckets with larger retentions that are relevant to the current user query.

Regarding the writing and curves of retention initialization, this process starts with raw information, a message, a decaying factor D, and a memory writing mechanism for information classification and similarity assessment. One possible embodiment is a user message during a chatbot interaction, but a message can be what happened during an event between agents.

Regarding the rate of forgetting “D,” from the beginning, the embodiments rely on the rate of forgetting D, which can optionally be provided by the user or a computing entity (e.g., ML engine 210 of FIG. 2). The higher the value of D, the lower the memory decay rate. The entity providing the value should consider the factors listed below when deciding whether they want a more flexible (lower D) or permanent (larger D) memory bank.

One factor is a storage factor. Storages with relatively lower capacity might require small decaying factors since there is no possibility of retaining lots of memory items.

Another factor is a reading speed. Buckets are often searched in a greedy manner during the LLM reading procedure. If the application requires speed, too many buckets might inhibit the narrowing procedure.

Another factor is the LLM's capabilities. During the LLM reading procedure, it is expected that the user will leverage LLMs to extract only useful information from a given bucket. Determining what is useful might be a challenge for low-tier LLMs.

Raw information is processed by the disclosed writing mechanism. This mechanism receives the raw information, checks if the information is useful, processes the information into one or more memory items, categorizes it/them into buckets, and then adds the relevant content to the bucket (or to a preexisting one).

LLMs can be used for the above processes. For instance, a linguistic instruction analyzes the incoming content and then categorizes it (e.g., by creating or finding a similar bucket) based on a user preference, as in “classify the information based on the context.” Then, another linguistic instruction for this model is responsible for summarizing the content. The summarized content, namely “memory item now,” becomes part of the recently created or preexisting bucket. Another linguistic instruction, or any similarity measure is responsible to compare the triggered bucket to all other buckets in a pairwise manner.

Each bucket is composed of information that can either be related (not exclusively) to the same context (e.g., information solely about gardening, or cooking) or to the same structure (e.g., “The king rules” and “The chef cooks”). The similarity between buckets and items is related to the way the writing mechanism categorizes information and is thus application based. Memories within the same bucket have high similarity, and buckets have some similarity among them as well. Naturally, buckets are not totally similar; otherwise, they would be a single bucket. The embodiments leverage this similarity between buckets, treating it as a “zone of influence.”

A bucket is created when a memory finds no similarity (or at least a level of similarity that does not meet or exceed a predefined threshold) among existing buckets. In this case, a new bucket is initialized with timeTag=0, thereby yielding a retention of 1 according to the exponential decay equation shown in Expression 2. This also happens if the memory item is new. Expression 4 (below) depicts the elements for a bucket.

$${Bucket}_{i} = \{ [ {BucketKeyword}_{i} , {timeTag}_{i} , {Retention}_{i} , \{ {MemoryItem}_{ij} : \\ [ {memoryDescription}_{ij} , {timeTag}_{ij} , {Retention}_{ij} ] \} \} \qquad Expression 4$$

The description for a bucket is the summary of what that bucket represents. It might or might not be human-interpretable, such as natural language. The summary might be a hash that maps similar memories to this same hashing code. Despite the method, each description might be unique, while maintaining a degree of similarity with other buckets. The memory item description is the summarization of the information.

The zone of influence has a graph-like representation; thus, it can be represented in many ways. In a generalized way, the embodiments can represent a node (or a memory category) in the manner represented below by Expression 3.

$${Bucket}_{m} = \{ \{ {Bucket}_{n} , {weight}_{n} ) \vert n = 1 , 2 , … , k \} \qquad Expression 3$$

Where “Bucket” is a category of memory content, and the weight is the similarity between the bucket and adjacent memory buckets. It can be represented as well as an upper diagonal matrix, such as:

$$[ \begin{matrix}{weight}_{11} & {weight}_{12} & {weight}_{13} \\ - & {weight}_{22} & {weight}_{23} \\ - & - & {weight}_{33}\end{matrix} ]$$

Thus, as one step, service 205 of FIG. 2 is generally tasked with receiving information (“I”) (e.g., information 220A). It should be noted how service 205 includes a writing mechanism. This portion of the disclosure lists a number of steps using the terms “one,” “second,” “third,” and so on. It will be appreciated how these references are used to differentiate steps, and it might be the case that different steps are performed in an order that is different than the order presented herein or even in parallel with one another.

As a second step, service 205 (or, more particularly, the writing mechanism) classifies the information and turns it into a list of one or more memory descriptions or “memory items.” As a third step, each memory item is compared to memory items included in any number of existing memory buckets.

As a fourth step, for each memory item/description, service 205 checks if any bucket has items that are determined to be sufficiently similar (i.e. a similarity threshold is met). If the similarity threshold is not met, service 205 creates a new bucket and proceeds to step five. If the memory description can be associated with or included in an existing bucket, service 205 proceeds to step six.

As step five, if a new bucketᵢ is created, service 205 associates a timeTagᵢ=0 to it, a memoryItemᵢⱼ with the memoryDescriptionᵢⱼ, and a timeTagᵢ; to the memoryItemᵢⱼ. The bucket receives bucketKeywordᵢ, and then service 205 proceeds to step seven.

As step six, service 205 checks if the triggered bucket has a preexisting memoryDescription similar enough to the incoming memoryDescription. If so, service 205 subtracts 1 from the respective memoryItem timeTag. Service 205 creates a different memoryItem otherwise, with timeTag=0.

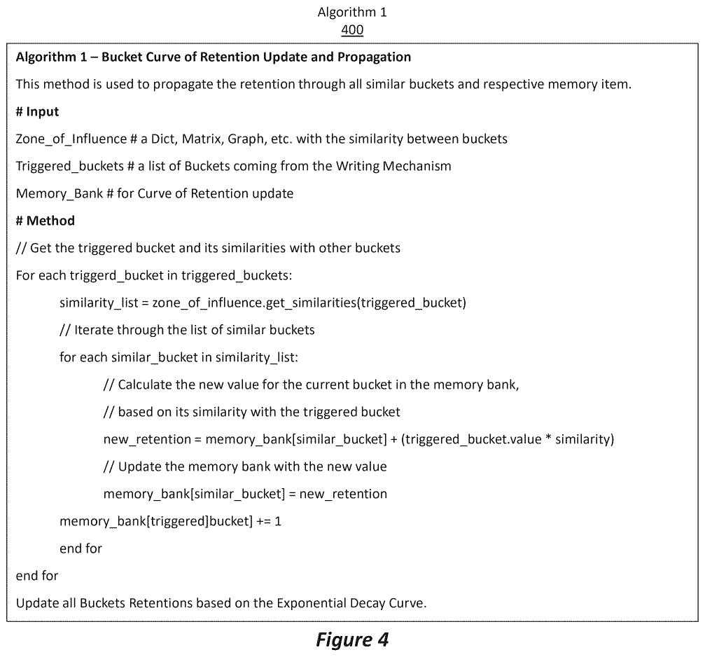

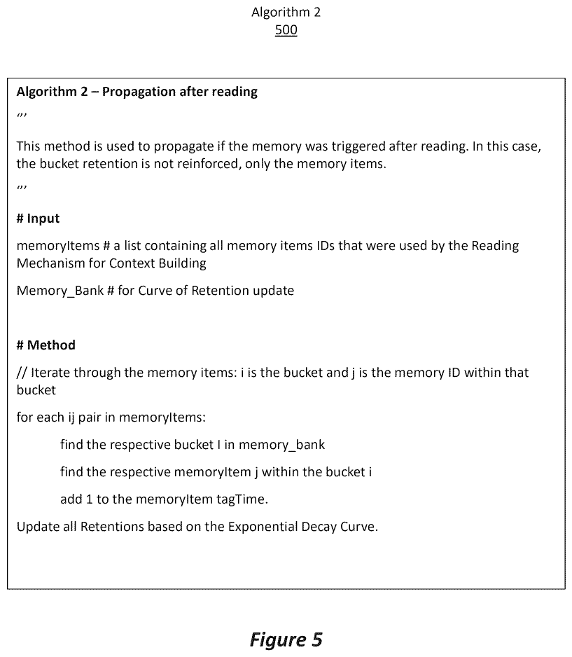

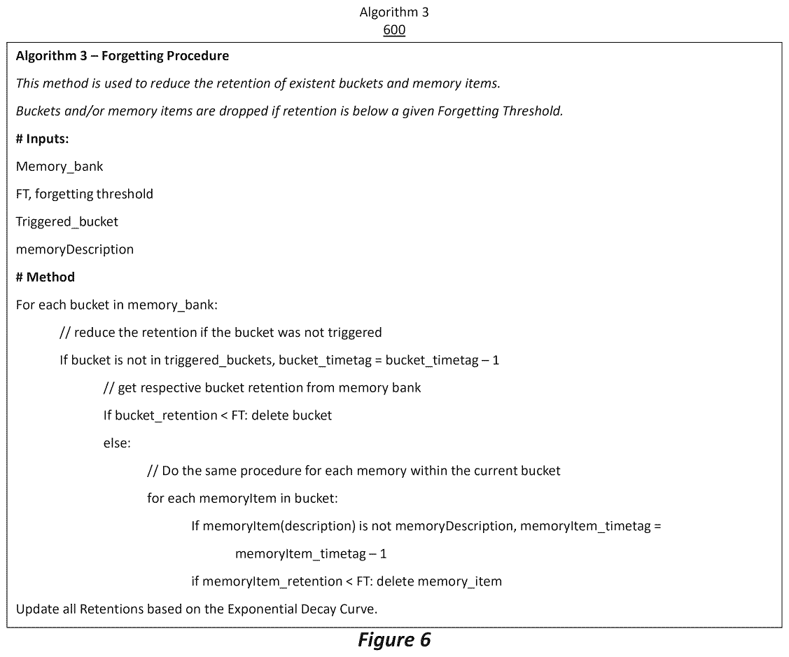

As step seven, service 205 assesses the similarity of the triggered or newly created bucket to other preexisting buckets. As step eight, service 205 propagates retentions and updates timeTags using Algorithm 1 shown in FIG. 4 as Algorithm 1 (400). As step nine, service 205 executes the LLM reading procedure. Service 205 also propagates using Algorithm 2 shown in FIG. 5 as Algorithm 2 (500). As step ten, service 205 runs Algorithm 3 shown in FIG. 6 as Algorithm 3 (600) (i.e. the forgetting procedure). As step eleven, service 205 waits for the next l.

Regarding the phrase “initialize curves of retention,” it is generally meant that service 205 sets the retention to a value of 1, which means that the input timeTag=0. Timetags can go below zero, but the retention is typically never larger than 1. This operates as a buffer for the curve of retention to illustrate that it is going to be harder to forget a memory item or memory category (bucket).

Algorithm 1 in FIG. 4 is how the embodiments reinforce or diminish the retention through the whole bucket graph considering the zone of influence. For such a goal, the embodiments can obtain the list of triggered bucket IDs, the current memory bank, and the zone of influence, which is the similarity between buckets. Triggered buckets have their timeTags added one unity; buckets that have some similarity to the triggered bucket have their timeTags added by 1 and multiplied by the similarity, which may float between 0 and 1. Typcially, the similarity would likely not extend beyond 70%. All retentions are updated based on the updated timetags and forgetting decay D.

Algorithm 2 in FIG. 5 (shown as Algorithm 2 500) is another propagation, which happens after context building, to resemble the refreshing in the memory when the embodiments are tasked with remembering something. Similar operations as those in Algorithm 1 occur, except that the bucket is not propagated, only the memory items. It is possible to assume this scenario because there can be the case where memory items might come from different buckets for context building, and triggering all buckets would not be worthwhile. Once again, after the timeTags are updated, the retention is recalculated.

Algorithm 3 600 in FIG. 6 reduces the retention and/or deletes bucket(s) and/or memory item(s) from the memory bank based on a user defined forgetting threshold. It is a greedy method that runs through one, some, or every bucket that was not triggered during the current interaction. If the bucket was not the one triggered, it reduces the bucket timeTag and checks if the retention is now below the allowed threshold. If so, the bucket is removed together with all memory items within. If not, the method checks all memory items within the ongoing bucket to check if there is a match with the memoryDescription coming from the writing mechanism. If not, the respective memoryItem timeTag is reduced by one and the respective retention is recalculated. Once again, if the retention is below the allowed threshold, that specific memoryItem from the bucket is deleted.

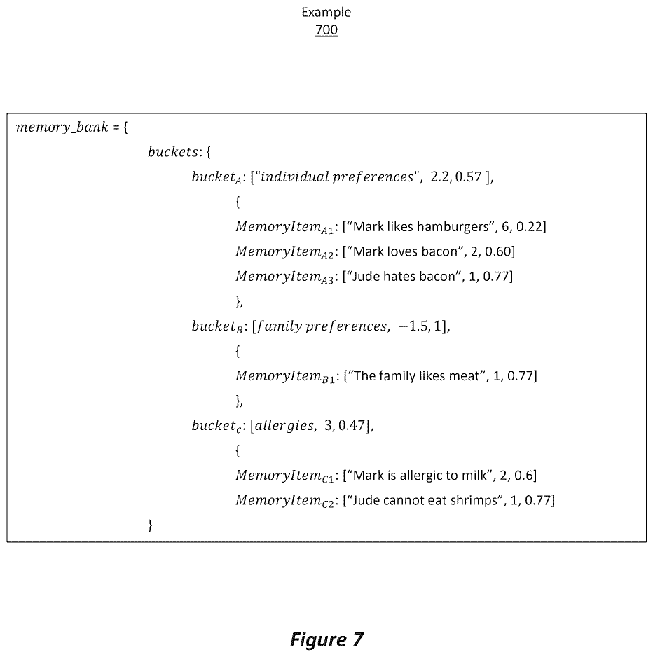

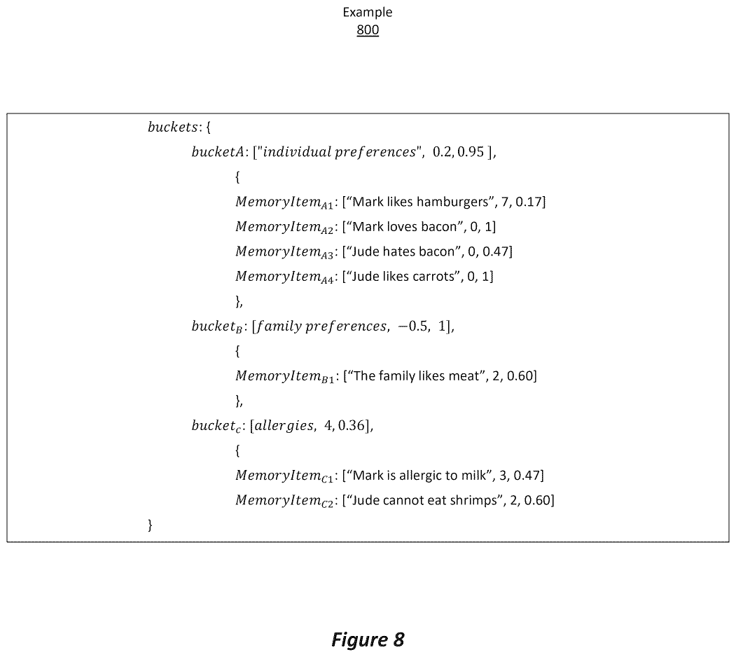

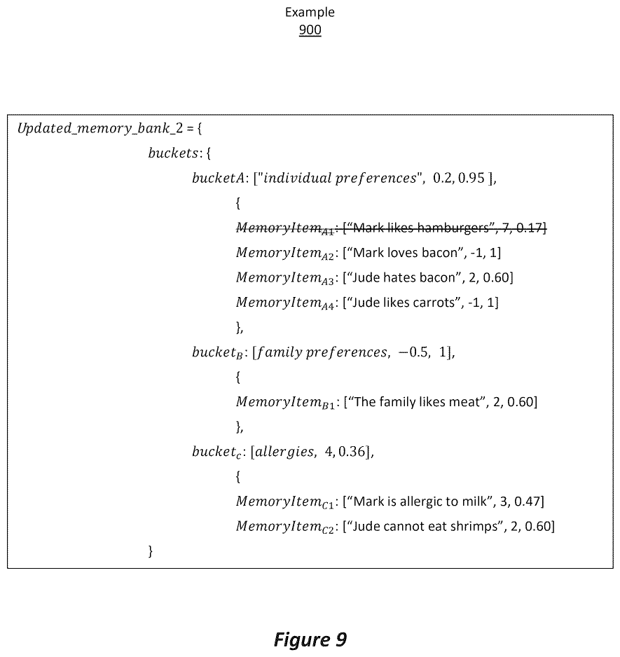

An example will now be provided to illustrate the memory bank with buckets and similarity matrix. This example, which is shown in FIG. 7 by Example 700 as well as FIGS. 8 and 9, involves a hypothetical in-progress memory bank. In this possible embodiment, the agent is tasked with helping the user to find suitable recipes for a family. The writing mechanism ended up splitting some information obtained during prior conversations into three buckets: individual preferences, family preferences, and allergies. In FIG. 7, the number next to each bucket keyword and to each memory item is the timeTag, which tells service 205 how far from a retention of 1 they are. The timeTags for the buckets are fractions due to previous propagation(s) based on zone of influence similarity. The value next to the timeTag, between 0 and 1, is the retention.

In FIG. 7, notice that the bucket “family preferences” has a negative timeTag, meaning that the retention is 1 (since it is capped) and that there is a buffer before losing retention. Now, suppose the user has set a forgetting threshold of 0.3, forgetting factor D of 3, and a similarity threshold of 0.6. The following disclosure will simulate a full interaction starting with the message.

User Input: “Hi, Chatbot. Jude here. I bought something that I hate because of Mark, bacon. I also bought something that I like, carrots! Please, suggest to me a recipe with these ingredients.”

Writing Mechanism Output:
memory description 1: Mark loves bacon. Bucket: Individual Preferences
memory description 2: Jude likes carrots. Bucket: Individual Preferences
memory description 3: Jude hates bacon. Bucket: Individual Preferences

Following Algorithm 1, since there are no new buckets, service 205 will update (i.e. subtract timeTags) the existing ones with each memory description. All other memory descriptions and buckets are going to have the respective timeTags added to a unit. The result is shown in FIG. 8 by Example 800.

At this moment, the reading procedure occurs. If any information is directly used for context building, the timeTag is added as well according to Algorithm 2. Suppose the reading mechanism suggests a carrot souffle for Jude and an omelet with bacon for Mark. Memory items A1, A3 will be updated once again as a refreshing bonus.

Now, during the forgetting stage, the MemoryItem_{A1} is going to be deleted since the respective retention is 17%, which is less than the forgetting threshold of 30% set by the user. The result is shown in FIG. 9 by Example 900.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

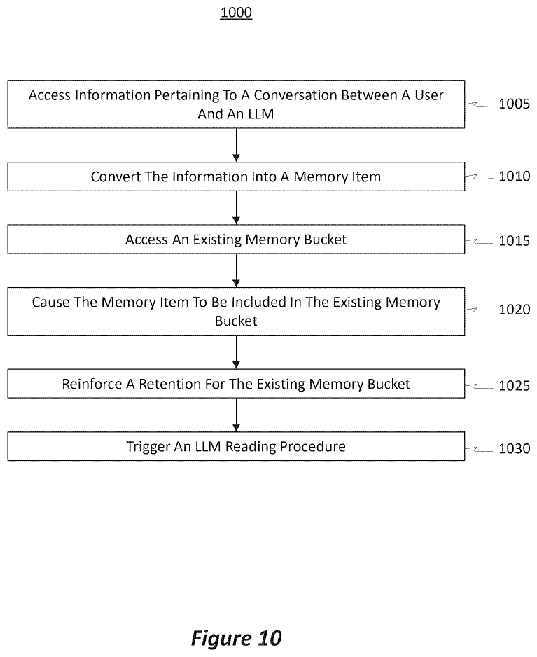

Attention will now be directed to FIG. 10, which illustrates a flowchart of an example method 1000 for providing a response to a conversation with an LLM. Method 1000 can be implemented within architecture 200 of FIG. 2. Method 1000 can be performed by service 205.

Method 1000 includes an act (act 1005) of accessing information (e.g., perhaps the information 220A from FIG. 2) pertaining to a conversation between a user and a large language model (LLM).

Act 1010 includes converting the information into a memory item. In some scenarios, converting the information into the memory item includes parsing the information.

Act 1015 includes accessing an existing memory bucket. A memory bucket is a grouping of memory items having characteristics that are determined to be within a threshold level of similarity relative to one another. The existing memory bucket is associated with a curve of retention.

In response to determining that a characteristic of the memory item satisfies the threshold level of similarity relative to the characteristics of the memory items in the existing memory bucket, act 1020 includes causing the memory item to be included in the existing memory bucket. If the threshold level of similarity was not satisfied, then a new memory bucket will be created for the memory item.

Act 1025 includes reinforcing a retention for the existing memory bucket. This reinforcement occurs by updating the curve of retention for the existing memory bucket.

Act 1030 includes triggering an LLM reading procedure. During this LLM reading procedure, memory buckets are searched in an attempt to identify data that is usable to provide an LLM response for the conversation. The LLM reading procedure is structured to assume that whichever memory bucket has the highest retention (as compared to the other memory buckets), that memory bucket is relatively more likely to include the data that is usable to provide the LLM response. In some implementations, the existing memory bucket is determined to be the memory bucket having the highest retention. In some implementations, a different memory bucket is determined to be the one having the highest retention.

In some scenarios, a curve of retention is assigned to the memory item. As a result, the existing memory bucket is associated with a curve of retention and the memory item, which is included in the existing memory bucket, is associated with a curve of retention.

Optionally, method 1000 includes some additional acts. For instance, one act includes determining that the memory item is redundant with an existing memory item that was previously included in the existing memory bucket. Another act includes identifying a curve of retention for the existing memory item. Yet another act includes reinforcing a retention for the existing memory item by updating that curve of retention.

Additionally, or alternatively, method 1000 may further include some additional acts. One act includes identifying a second existing memory bucket that is determined to satisfy a second threshold level of similarity relative to the existing memory bucket. This threshold may be the same as the earlier threshold or it may be different. In response to reinforcing the retention for the existing memory bucket (e.g., by updating the curve of retention for the existing memory bucket), another act includes reinforcing a retention for the second existing memory bucket (and any additional memory buckets that are in the zone of influence) by updating a second curve of retention for the second existing memory bucket. The process of reinforcing the second retention is performed based on the determination that the second existing memory bucket is in the zone of influence of the existing memory bucket (based on the second existing memory bucket satisfies the second threshold level of similarity relative to the existing memory bucket). Thus, any bucket in the zone of influence may also be updated.

Additionally, or alternatively, method 1000 may further include a number of other acts. One act includes identifying a second existing memory bucket. Optionally, the second existing memory bucket is associated with a second curve of retention. Another act includes determining that the second existing memory bucket does not satisfy a second threshold level of similarity relative to the existing memory bucket. In response to reinforcing the retention for the existing memory bucket, another act includes refraining from reinforcing a second retention for the second existing memory bucket. In response to determining that the second retention does not satisfy a memory threshold, another act includes dropping the second existing memory bucket by deleting the second existing memory bucket.

Additionally, or alternatively, method 1000 may further include some additional acts. One act includes using the existing memory bucket to acquire the data that is usable to provide the LLM response. Another act includes providing the LLM response to the conversation.

In some implementations, curves of retention, including the ones mentioned above, include decaying factors. These decaying factors cause retentions (or memory strength) for memory items or retentions for memory buckets to reduce over time.

Additionally, or alternatively, method 1000 may further include some additional acts. One act includes converting second information into a second memory item. Another act includes determining that a characteristic of the second memory item does not satisfy the threshold level of similarity relative to characteristics for any existing memory items in any existing memory buckets. Another act includes creating a new memory bucket and including the second memory item in the new memory bucket. Another act includes assigning the new memory bucket a new curve of retention. Yet another act includes assigning the second memory item a curve of retention.

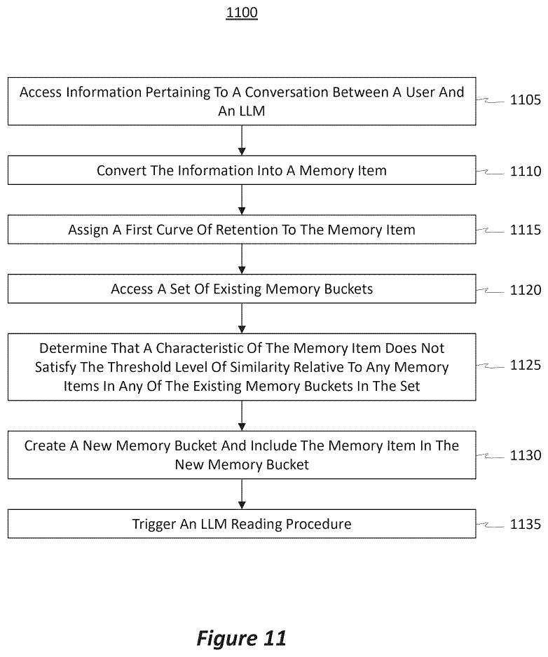

Attention will now be directed to FIG. 11, which illustrates a flowchart of an example method 1100 for providing a response to a conversation with an LLM. Method 1100 may also be performed by service 205 of FIG. 2.

Method 1100 includes an act (act 1105) of accessing information pertaining to a conversation between a user and a large language model (LLM). Act 1110 includes converting the information into a memory item.

Act 1115 includes assigning a first curve of retention to the memory item. The first curve of retention includes a decaying factor that operates to decay a memory strength, which is represented by the first curve of retention, for the memory item.

Act 1120 includes accessing a set of existing memory buckets, each of which is a corresponding grouping of memory items having characteristics that are determined to be within a threshold level of similarity relative to one another. Each existing memory bucket in the set is associated with a corresponding curve of retention.

Act 1125 includes determining that a characteristic of the memory item does not satisfy the threshold level of similarity relative to any memory items in any of the existing memory buckets in the set. Act 1130 includes creating a new memory bucket and including the memory item in the new memory bucket. The new memory bucket is caused to be associated with a second curve of retention.

Act 1135 includes triggering an LLM reading procedure during which memory buckets are searched in an attempt to identify data that is usable to provide an LLM response for the conversation. The LLM reading procedure is structured to assume that whichever memory bucket has the highest retention is relatively more likely to include the data that is usable to provide the LLM response.

Additionally or alternatively, method 1100 may include other acts. For instance, one act includes identifying an existing memory bucket that is determined to satisfy a second threshold level of similarity relative to the new memory bucket. Thus, this existing memory bucket is in the zone of influence of the new memory bucket. Another act includes reinforcing a retention for the existing memory bucket by updating a third curve of retention for the existing memory bucket. Reinforcing the second retention is performed based on the determination that the existing memory bucket satisfies the second threshold level of similarity relative to the new memory bucket. That is, because the new bucket was created and because the existing bucket satisfies the similarity threshold, the existing bucket's retention will be increased/updated because it is within the zone of influence of the new bucket.

Additionally or alternatively, method 1100 may include other acts. For instance, one act includes identifying an existing memory bucket. Optionally, the existing memory bucket is associated with a curve of retention. Another act includes determining that the existing memory bucket does not satisfy a second threshold level of similarity relative to the new memory bucket. Another act includes refraining from reinforcing a retention for the existing memory bucket. In response to determining that the retention does not satisfy a memory threshold, another act includes dropping the existing memory bucket by deleting the existing memory bucket.

Optionally, the new memory bucket is determined to be the memory bucket having the highest retention. As another option, converting the information into the memory item includes parsing the information.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

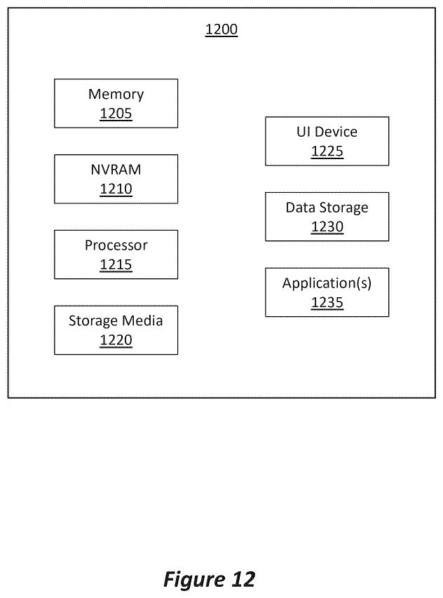

With reference briefly now to FIG. 12, any one or more of the entities disclosed, or implied, by the Figures and/or elsewhere herein, may take the form of, or include, or be implemented on, or hosted by, a physical computing device, one example of which is denoted at 1200. This example device can be implemented in architecture 200 of FIG. 2 and can host service 205. Also, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1205 which may include one, some, or all, of random access memory (RAM), non-volatile memory (NVM) 1210 such as NVRAM for example, read-only memory (ROM), and persistent memory, one or more hardware processors 1215, non-transitory storage media 1220, UI device 1225, and data storage 1230. One or more of the memory 1205 of the physical computing device 1200 may take the form of solid-state device (SSD) storage. Also, one or more applications 1235 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 1200 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
accessing information pertaining to a conversation between a user and a large language model (LLM);
converting the information into a memory item;
accessing an existing memory bucket, which is a grouping of memory items having characteristics that are determined to be within a threshold level of similarity relative to one another, wherein the existing memory bucket is associated with a curve of retention;
in response to determining that a characteristic of the memory item satisfies the threshold level of similarity relative to the characteristics of the memory items in the existing memory bucket, causing the memory item to be included in the existing memory bucket;
reinforcing a retention for the existing memory bucket by updating the curve of retention for the existing memory bucket; and
triggering an LLM reading procedure during which memory buckets are searched in an attempt to identify data that is usable to provide an LLM response for the conversation, wherein the LLM reading procedure is structured to assume that whichever memory bucket has a highest retention as compared to other ones of said memory buckets, that memory bucket is relatively more likely to include the data that is usable to provide the LLM response.

2. The method of claim 1, wherein converting the information into the memory item includes parsing the information.

3. The method of claim 1, wherein a second curve of retention is assigned to the memory item such that the existing memory bucket is associated with the curve of retention and the memory item, which is included in the existing memory bucket, is associated with the second curve of retention.

4. The method of claim 1, wherein the method further includes:
determining that the memory item is redundant with an existing memory item that was previously included in the existing memory bucket;
identifying a second curve of retention that is associated with the existing memory item; and
reinforcing a retention for the existing memory item by updating the second curve of retention.

5. The method of claim 1, wherein the method further includes:
identifying a second existing memory bucket that is determined to satisfy a second threshold level of similarity relative to said existing memory bucket such that the second existing memory bucket is in a zone of influence of said existing memory bucket; and
in response to reinforcing the retention for the existing memory bucket by updating the curve of retention for the existing memory bucket, reinforcing a second retention for the second existing memory bucket by updating a second curve of retention for the second existing memory bucket, wherein reinforcing the second retention is performed based on the determination that the second existing memory bucket is in the zone of influence of the existing memory bucket.

6. The method of claim 1, wherein the method further includes:
identifying a second existing memory bucket, wherein the second existing memory bucket is associated with a second curve of retention;
determining that the second existing memory bucket does not satisfy a second threshold level of similarity relative to said existing memory bucket;
in response to reinforcing the retention for the existing memory bucket, refraining from reinforcing a second retention for the second existing memory bucket; and
in response to determining that the second retention does not satisfy a memory threshold, dropping the second existing memory bucket by deleting the second existing memory bucket.

7. The method of claim 1, wherein said existing memory bucket is determined to be the memory bucket having the highest retention.

8. The method of claim 1, wherein the method further includes:
using the existing memory bucket to acquire the data that is usable to provide the LLM response; and
providing the LLM response to the conversation.

9. The method of claim 1, wherein curves of retention, including said curve of retention, include decaying factors that cause retentions for memory items or retentions for memory buckets to reduce over time.

10. The method of claim 1, wherein the method further includes:
converting second information into a second memory item;
determining that a second characteristic of the second memory item does not satisfy the threshold level of similarity relative to characteristics for any existing memory items in any existing memory buckets;
creating a new memory bucket and including the second memory item in the new memory bucket;
assigning the new memory bucket a new curve of retention; and
assigning the second memory item a second new curve of retention.

11. A method comprising:
accessing information pertaining to a conversation between a user and a large language model (LLM);
converting the information into a memory item;
assigning a first curve of retention to the memory item, the first curve of retention including a decaying factor that operates to decay a memory strength, which is represented by the first curve of retention, for the memory item;
accessing a set of existing memory buckets, each of which is a corresponding grouping of memory items having characteristics that are determined to be within a threshold level of similarity relative to one another, wherein each existing memory bucket in the set is associated with a corresponding curve of retention;
determining that a characteristic of the memory item does not satisfy the threshold level of similarity relative to any memory items in any of the existing memory buckets in the set;
creating a new memory bucket and including the memory item in the new memory bucket, wherein the new memory bucket is caused to be associated with a second curve of retention; and
triggering an LLM reading procedure during which memory buckets are searched in an attempt to identify data that is usable to provide an LLM response for the conversation, wherein the LLM reading procedure is structured to assume that whichever memory bucket has a highest retention as compared to other ones of said memory buckets, that memory bucket is relatively more likely to include the data that is usable to provide the LLM response.

12. The method of claim 11, wherein the method further includes:
identifying an existing memory bucket that is determined to satisfy a second threshold level of similarity relative to said new memory bucket; and
reinforcing a retention for the existing memory bucket by updating a third curve of retention for the existing memory bucket, wherein reinforcing the second retention is performed based on said determination that the existing memory bucket satisfies the second threshold level of similarity relative to said new memory bucket.

13. The method of claim 11, wherein the method further includes:
identifying an existing memory bucket, wherein the existing memory bucket is associated with a third curve of retention;
determining that the existing memory bucket does not satisfy a second threshold level of similarity relative to said new memory bucket;
refraining from reinforcing a retention for the existing memory bucket; and
in response to determining that the retention does not satisfy a memory threshold, dropping the existing memory bucket by deleting the existing memory bucket.

14. The method of claim 11, wherein said new memory bucket is determined to be the memory bucket having the highest retention.

15. The method of claim 11, wherein converting the information into the memory item includes parsing the information.

16. A computer system comprising:
one or more processors; and
one or more hardware storage devices that store instructions that are executable by the one or more processors to cause the computer system to:
access information pertaining to a conversation between a user and a large language model (LLM);
convert the information into a memory item;
access an existing memory bucket, which is a grouping of memory items having characteristics that are determined to be within a threshold level of similarity relative to one another, wherein the existing memory bucket is associated with a curve of retention;
in response to determining that a characteristic of the memory item satisfies the threshold level of similarity relative to the characteristics of the memory items in the existing memory bucket, cause the memory item to be included in the existing memory bucket;
reinforce a retention for the existing memory bucket by updating the curve of retention for the existing memory bucket; and
trigger an LLM reading procedure during which memory buckets are searched in an attempt to identify data that is usable to provide an LLM response for the conversation, wherein the LLM reading procedure is structured to assume that whichever memory bucket has a highest retention as compared to other ones of said memory buckets, that memory bucket is relatively more likely to include the data that is usable to provide the LLM response.

17. The computer system of claim 16, wherein converting the information into the memory item includes parsing the information.

18. The computer system of claim 16, wherein a second curve of retention is assigned to the memory item such that the existing memory bucket is associated with the curve of retention and the memory item, which is included in the existing memory bucket, is associated with the second curve of retention.

19. The computer system of claim 16, wherein the instructions are further executable to cause the computer system to:
determine that the memory item is redundant with an existing memory item that was previously included in the existing memory bucket;
identify a second curve of retention that is associated with the existing memory item; and
reinforce a retention for the existing memory item by updating the second curve of retention.

20. The computer system of claim 16, wherein the instructions are further executable to cause the computer system to:
identify a second existing memory bucket that is determined to satisfy a second threshold level of similarity relative to said existing memory bucket; and
in response to reinforcing the retention for the existing memory bucket by updating the curve of retention for the existing memory bucket, reinforce a second retention for the second existing memory bucket by updating a second curve of retention for the second existing memory bucket, wherein reinforcing the second retention is performed based on the determination that the second existing memory bucket satisfies the second threshold level of similarity relative to said existing memory bucket.
